(19) United States
(12) Patent Application Publication
(10) Pub. No.: US 2002/0073235 A1
(43) Pub. Date: Jun. 13, 2002

(54) System and method for content distillation

(76) Inventors: Steve X. Chen, Berkeley, CA (US); Ken Chen, Berkeley, CA (US)

Correspondence Address: SKJERVEN MORRILL MACPHERSON LLP, 25 METRO DRIVE, SUITE 700, SAN JOSE, CA, 95110, US

(21) Appl. No.: 09/734,499

(22) Filed: Dec. 11, 2000

(51) Int. Cl. G06F 15/16

(52) U.S. Cl. 709/246; 709/218; 709/219

(57) ABSTRACT

A system and method is provided for transferring information, such as Internet content. The system may provide freeform browsing on a wireless limited-display device, Internet content distillation, targeted content delivery based on a user's location, one-hop delivery of Internet content to a wireless limited-display device, Internet content flagging and synchronization of information between a wireless limited-display device and another device such as a personal computer (PC).

### CROSS REFERENCE TO RELATED APPLICATIONS

The present Application is related to U.S. patent applications entitled “System and Method for Coordinating Content Between Devices”, Attorney Docket Number M-9547, “System and Method for Caching Content”, Attorney Docket Number M-9548, “System and Method for Synchronizing Content Between Devices”, Attorney Docket Number M-9550, and “System and Method for Targeted Content Delivery”, Attorney Docket Number M-9713, co-filed with the present patent application, assigned to the Assignee of the present invention, and are hereby incorporated by reference in their entireties.

### BACKGROUND OF THE INVENTION

1. Field of the Invention

The present invention relates to transferring data in electronic form, such as Internet content.

2. Description of Related Art

Some wireless devices, such as cellular telephones and personal digital assistants (PDAs), have been configured to access and display a portion of the content that is available on the Internet. In general, these wireless, limited-display devices can only display a limited amount of such Internet content at one time. Most Internet users, however, strongly desire near-instantaneous access to all Internet content.

### SUMMARY

“Internet content” may refer to web pages, navigation links, pieces of text, tables, graphics, videos, audio samples, Hyper Text Markup Language (HTML) files, emails, etc. Conventional techniques of accessing and displaying Internet content on wireless, limited-display devices, such as wireless phones and PDAs, have several drawbacks. First, Internet content is formatted for desktop displays of personal computers (PCs), and not for wireless, limited-display devices.

Second, to provide the same Internet content for wireless, limited-display devices, separate, specially formatted web pages must be created. This requires a website company to manually convert (“hand code” or trans-code or re-write) standard PC-formatted web pages to special web pages that fit on the limited-displays of some wireless devices. But this manual formatting is time-consuming, costly and inefficient. For example, many web sites, such as ESPN or CNN, have a large number of web pages, each of which may have a large amount of content or links.

Because the creation of web pages specially formatted for wireless, limited display devices is not trivial, many standard PC-formatted web pages are not available at all for wireless, limited-display devices. Even if a web page is specially formatted and available for a wireless, limited-display device, some items on a corresponding PC-formatted web page may not be available on the limited-display-formatted web page. This unavailability of web pages or certain items of a web page for a wireless, limited-display device may be called the “walled garden” problem.

In addition, every time a website company changes the format or adds content to its PC-size web pages, the company has to manually convert the new PC-size web pages to wireless, limited-display device web pages.

Third, a web page manually formatted to be displayed on one wireless, limited-display device, such as a Nokia wireless phone, may not be formatted for display on other wireless, limited-display devices, such as a Palm Pilot VII. The website company may have to create special web pages to accommodate each type of wireless, limited-display device.

Fourth, users of wireless, limited-display devices may have to wait extended periods of time for servers to download Internet content and/or convert PC-size web pages to wireless, limited-display device web pages. These delays are frustrating to wireless, limited-display device users.

Fifth, users of wireless, limited-display devices may have to press scroll keys (e.g., up, down, left, right) several times to view a web page on their wireless, limited-display devices. For example, a user may need 65 “down-clicks” to view a web page on a Palm Pilot or 120 “down-clicks” to view a page on a Wireless Application Protocol (WAP) phone. Each “click” may require additional time delays for processing and downloading content. A user may have to spend a lot of time to find the most relevant information on a web page displayed on a limited-display device.

The present invention solves the foregoing drawbacks by providing a system and method for transferring information, such as Internet content, to a limited-display device. One embodiment of the present method advantageously transforms any PC-size web page or Internet content from any web server automatically on-the-fly to provide real-time Internet access to wireless, limited-display devices. This real-time access to any web page may be called “freeform browsing.”

One embodiment of the present system comprises an intelligent server-based system that distills Internet content on a PC-size web page for presentation at a wireless, limited-display device. The system may use one or more methods to determine or identify what is the most important or desired Internet content. These methods may be referred to as “distilling content” or “content distillation.” The system is advantageously accessible to host companies that want to control the content and/or format of their own web sites for wireless, limited-display devices.

One advantage of the system is the real-time availability of Internet content that was previously unavailable on limited-display devices.

Another advantage of the system is reducing the time and costs associated with manually converting or hand-coding PC-size web pages to limited-display device web pages. One embodiment of the present system may convert a PC-size web page to a limited-display device web page in a fraction of the time and at significantly less expense than hand-coding or trans-coding.

Yet another advantage of the system is allowing companies to easily add content or change the format of their web pages for limited-display devices.

Still another advantage of the system is formatting web pages and Internet content in real time according to the individual specifications of various limited-display devices.

Still yet another advantage of the system is reducing the number of scroll key movements to view a web page on a wireless, limited-display device because of content distillation.

Another advantage of the system is targeting content delivery based on a user's location. The system may determine a user's location and transfer local or regional news, weather, sports, business and/or advertising to a particular limited-display device, with or without a user request.

Another advantage of the system is minimizing the time that users are required to wait to access certain Internet content on their limited-display devices. The system provides cache machines that cache previously-requested Internet content or Internet content posted by companies that host web sites. By caching Internet content, the system reduces the number of transmissions (“hops”) between network components, minimizes user waiting time (“latency”), improves performance and saves bandwidth. The cache machines also allow host companies with web sites to directly modify their cached Internet content for limited-display devices. The cache machines may be advantageously located outside a host company's firewalls. The host companies do not have to modify their existing corporate web infrastructures. The placement of the cache machines ensures a high level of security and does not overburden the firewalls with excessive traffic.

Another advantage of the system is sending targeted advertisements based on user-requested Internet content to limited-display devices.

Another advantage of the system is coordinating Internet browsing on two separate devices. When the user browses the Internet on a first device, such as a limited-display device, the system keeps track of items of interest that the user checks or flags, such as emails and news articles. The system may also track browsing footsteps of the user. When the user accesses a second device, such as a personal computer, the system retrieves the checked or flagged items of interest and/or browsing footsteps of the user. Thus, the system saves time for users who flag certain Internet items on a portable device “on-the-go” and later wish to access those items quickly at another device at home, at an office, in a hotel room, on a plane, at a conference, etc. The user does not have to retrace his/her steps at the second device.

One aspect of the invention relates to a system for transferring Internet content to a limited-display device. The system comprises a content control server in communication with a web server and a limited-display device. The content control server is configured to store one or more customized parsing scripts. The content control server is further configured to process a user request for Internet content to be displayed on the limited-display device. The content control server is further configured to execute one or more customized parsing scripts to parse items in the user-requested Internet content in real time. The content control server is further configured to transfer parsed Internet content to the limited-display device.

Another aspect of the invention relates to a system for transferring Internet content to a limited-display device. The system comprises a content control server in communication with a web server and a limited-display device. The content control server is configured to receive a request for Internet content to be displayed on the limited-display device. The content control server is further configured to parse PC-formatted Internet content in real time. The content control server is further configured to transfer the parsed Internet content to the limited-display device.

Another aspect of the invention relates to a method of transferring Internet content to a limited-display device. The method comprises receiving a request for Internet content to be displayed on a limited-display device; transforming PC-formatted Internet content into limited-display-formatted Internet content in real time; and transferring the limited-display-formatted Internet content to the limited-display device.

Another aspect of the invention relates to a method of transferring Internet content to a wireless device based on a location of the wireless device. The method comprises determining a location of a wireless device; distilling Internet content based on the location of the wireless device; and sending the distilled Internet content to the wireless device.

Another aspect of the invention relates to a system for transferring Internet content to a wireless device based on a location of the wireless device. The system comprises a content control server in communication with a web server and a wireless device. The content control server is configured to distill Internet content from the web server based on the location of the wireless device in real time. The content control server is further configured to transfer the distilled Internet content to the wireless device.

Another aspect of the invention relates to a system for storing Internet content. The system comprises a storage device in communication with one or more wireless limited-display devices and one or more web site servers. The storage device is configured to store Internet content from the web site servers and transfer the Internet content to the wireless limited-display devices.

Another aspect of the invention relates to a method for retrieving Internet content. The method comprises receiving a request for Internet content to be displayed on a wireless limited-display device; determining whether the requested Internet content is stored in a storage device in communication with one or more wireless limited-display devices and one or more web site servers; if the requested Internet content is stored in the storage device, retrieving the requested Internet content from the storage device and sending the Internet content to the wireless limited-display device.

Another aspect of the invention relates to a system for coordinating Internet activities between devices. The system comprises a coordination server in communication with a first device and a second device. The first device is configured to access the Internet. The coordination server is configured to store one or more Internet items selected by a user on the first device and provide the one or more stored Internet items to the second device, wherein at least one of the devices is a wireless limited-display device.

Another aspect of the invention relates to a system for coordinating Internet activities between devices. The system comprises a coordination server in communication with a first device and a second device. The first device is configured to access the Internet. The coordination server is configured to store one or more Internet navigation steps of a user as the user accesses the Internet on the first device and provide the one or more Internet navigation steps to the second device, wherein at least one of the devices is a wireless limited-display device.

Another aspect of the invention relates to a method for coordinating Internet activities between devices. The method comprises storing one or more Internet items selected by a user on a first device; and sending the one or more stored Internet items to a second device, wherein at least one of the devices is a wireless limited-display device.

Another aspect of the invention relates to a method for coordinating Internet activities between devices. The method comprises storing one or more Internet navigation steps by a user as the user accesses the Internet on a first device; and sending the one or more stored Internet navigation steps to a second device, wherein at least one of the devices is a wireless limited-display device.

Another aspect of the invention relates to a system for coordinating information between devices. The system comprises a coordination server in communication with a first device and a second device. The coordination server is configured to copy updated information entered by the user on the first device to the second device for storage, where the transfer occurs in real time and at least one of the devices is a wireless limited-display device.

Another aspect of the invention relates to a method for coordinating information between devices. The method comprises copying information entered by a user on a first device to a second device for storage. The transfer occurs in real time, wherein at least one of the devices is a wireless limited-display device.

The present invention will be more fully understood upon consideration of the detailed description below, taken together with the accompanying drawings.

### BRIEF DESCRIPTION OF THE DRAWINGS

FIG. 1 illustrates an environment in which one or more systems, according to embodiments of the present invention, may operate to transfer Internet content to a plurality of wireless, limited-display devices.

FIG. 2 illustrates an environment for a system, according to an embodiment of the present invention, for transforming Internet content to accommodate one or more wireless, limited-display devices.

FIG. 3 illustrates one embodiment of a method related to the system of FIG. 2.

FIG. 4 illustrates an environment for a system, according to an embodiment of the present invention, for caching Internet content.

FIG. 5 illustrates one embodiment of a method for caching and retrieving Internet content using the system of FIG. 4.

FIG. 6 illustrates an environment for a system, according to an embodiment of the present invention, for coordinating browsing activities between a PC and one or more limited-display devices.

FIG. 7 illustrates one embodiment of a method for coordinating browsing activities between a PC and one or more limited-display devices using the system of FIG. 6.

FIG. 8 illustrates one embodiment of a table used by the system of FIG. 6.

Use of the same reference symbols in different figures indicates similar or identical items.

### DETAILED DESCRIPTION

General Overview

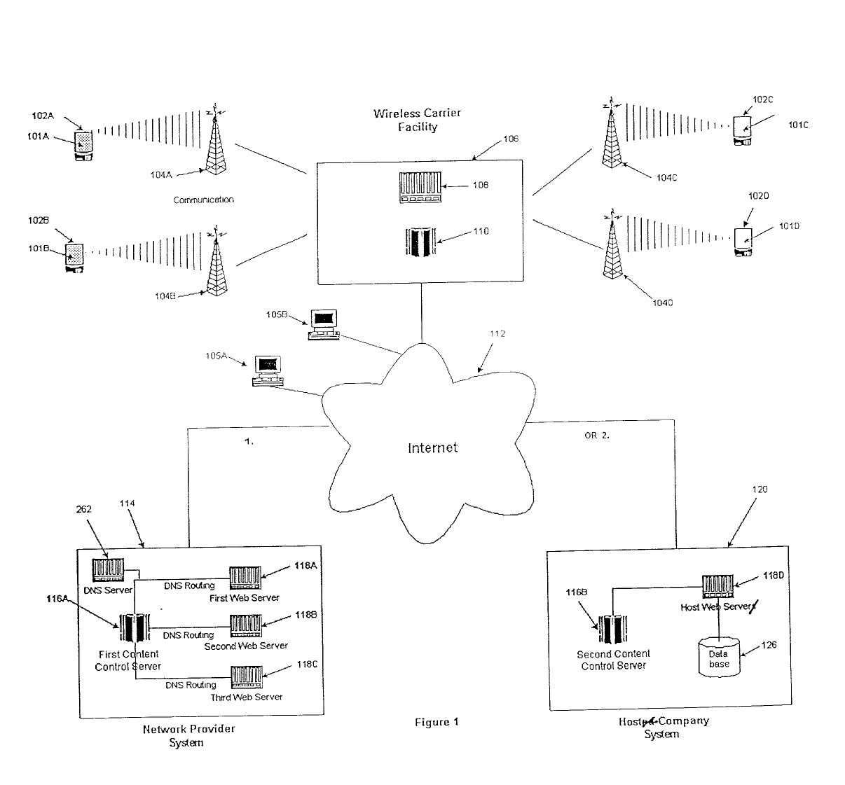

FIG. 1 illustrates an environment in which one or more system, according to embodiments of the present invention, may operate. The environment comprises a first wireless, limited-display device 102A, a second wireless, limited-display device 102B, a third wireless, limited-display device 102C, a fourth wireless, limited-display device 102D, a first communication tower (e.g., at a base station) 104A, a second communication tower 104B, a third communication tower 104C, a fourth communication tower 104D, a first client device 105A, a second client device 105B, a wireless carrier facility 106, the Internet 112, a network provider system 114 and a host company system 120 that hosts an Internet web site. In general, the environment may comprise any number of wireless, limited-display devices, communication towers, wireless carrier facilities, Internet, network providers and host company facilities.

Each wireless, limited-display device 102A, 102B, 102C, 102D of FIG. 1 may comprise a wireless telephone, a PDA, a pager or other wireless, limited-display device that is configured to access the Internet 112. The devices 102A, 102B, 102C, 102D, 102E, 102F and 102G are described herein as wireless devices. But the systems and methods herein may also be used to provide content to limited-display wired and/or stationary devices in communication with, for example, the wireless carrier facility 106 or the Internet 112. The term “limited-display” relates to a device with a physically small display or a device with a display that displays Internet data on a small portion of the display.

The wireless carrier facility 106 of FIG. 1, such as a wireless carrier facility operated by a telecommunications company, comprises one or more of mobile switching units 108 and one or more cache machines 110. The mobile switching units 108 control the traffic of data between the wireless carrier facility 106 and the wireless, limited-display devices 102A, 102B, 102C, 102D. Specifically, the mobile switching units 108 switch traffic from one base station (and its associated radio towers) to the next base station when a mobile user travels from one cell to another. The cache machines 110 comprise memory or storage devices configured to cache Internet content from the network provider system 114 and/or the host company system 120, as described below.

The wireless, limited-display devices 102A, 102B, 102C, 102D of FIG. 1 communicate with the communication towers 104A, 104B, 104C, 104D, which communicate with the wireless carrier facility 106. This communication may be supported by one or more forms of wireless communication, such as infrared, cellular, personal communication system (PCS), satellite, radiowaves, etc. The communication may use one or more standards or specifications, such as CDMA, WAP, Blue Tooth, etc., operated by a telecommunications company. The wireless carrier facility 106 communicates with the network provider system 114 and the host company system 120 via the Internet 112.

The Internet 112 of FIG. 1 may comprise a wired and/or wireless system. The Internet 112 may use standard telephone lines, xDSL, cable or other communication means. Internet 112 is an interconnection of computer “clients” and “servers” located throughout the world and exchanging information according to Transmission Control Protocol/Internet Protocol (TCP/IP), Internetwork Packet eXchange/Sequence Packet eXchange (IPX/SPX), AppleTalk, or other suitable protocol. Internet 112 supports the distributed application known as the “World Wide Web.” Web servers maintain websites, each comprising one or more web pages at which information is made available for viewing. Each website or web page can be identified by a respective uniform resource locator (URL) and may be supported by documents formatted in any suitable language, such as, for example, hypertext markup language (HTML), extended markup language (XML), or standard generalized markup language (SGML). Clients may locally execute a “web browser” program. A web browser is a computer program that allows the exchange of information with the World Wide Web. Any of a variety of web browsers are available, such as NETSCAPE NAVIGATOR from Netscape Communications Corp., INTERNET EXPLORER from Microsoft Corporation, and others that allow convenient access and navigation of the Internet 112. Information may be communicated from a web server to a client using a suitable protocol, such as, for example, HyperText Transfer Protocol (HTTP) or File Transfer Protocol (FTP). The Internet 112 provides communication between the wireless carrier facility 106, client devices 105A, 105B, the network provider system 114, the host company system 120 and other devices, such as laptops, desktop computers and computer servers (not shown). The Internet 112 transfers Internet content, user requests and data entered by users.

Network provider system 114 can be operated by a network provider company. Such a network provider company maintains the systems which support the networks for connecting users to the websites of various host companies which provide content on the Internet 112. The network provider system 114 of FIG. 1 comprises a domain name system (DNS) server 262, a first host web site server 118A, a second host web site server 118B, a third host web site server 118C and a first content control server 116A. The network provider system 114 may comprise any number of DNS servers, host web site servers and content control servers. Some or all of the host web site servers 118A, 118B, 118C may be grouped into cages. The web site servers 118A-118C may be located in different cages or on different floors, or on different network sites.

The first content control server 116A and the DNS server 262 may communicate with the host web site servers 118A-118C via DNS routing. For example, the DNS server 262 is the first to receive a request from the Internet 112 for a web site, which is hosted by the network provider system 114. The network provider system 114 may host web sites for thousands of companies. The DNS server 262 ordinarily routes requests to each host web site server 118A-118C.

The content control server 116A and the host company servers 118A-118C may or may not be located on the same floor, building, or network provider site. But the content control server 116A and the host company servers 118A-118C reside on the network provider's network and communicate with one or more DNS servers maintained by the network provider.

The host company facility 120 can be operated by a host company which supplier content for the Internet 112. Such host company can be an entity which operates or maintains a portal or any other website through which content can be delivered. For example, the host company can be on-line retailer of merchandise, an on-line news service, and the like. The host company system 120 of FIG. 1 comprises a host company web site server 118D, a host company database 126 and a second content control server 116B. The host company system 120 may comprise any number of host company web site servers, host company databases and content control servers. The host company database 126 stores content used by the web site server 118D.

After a host company subscribes to a content control company's system (e.g., NetOsprey) and adopts methods described herein, both the host company and the content control company would request the network provider to change one or more of the settings in the DNS server 262. Specifically, the DNS server 262 would direct all requests for the host company's web site to go to the content control server 116A.

After a host company subscribes to a content control company's services and adopts methods described herein, both the host company and the content control company may request the network provider to change one or more of the settings in the DNS server 262. Specifically, the DNS server 262 would direct all requests for the host company's web site to go to the content control server 116A.

The first and second content control servers 116A and 116B may be supplied, configured, and/or maintained by a content control company. Content control company may provide a service to which a host company subscribes in order to provide an enhanced experience for users. The first and second content control servers 116A, 116B of FIG. 1 may be standard computer servers or general purpose machines that are capable of executing software to perform the methods described herein, such as freeform browsing, content distillation, caching and device display coordination. Alternatively, the first and second content control servers 116A, 116B may be devices specifically configured to perform one or more of the methods described herein.

In one embodiment, a host company has its host web site server 118A controlled by the first content control server 116A in the network provider system 114. In another embodiment, a host company has its host company web site server 118D controlled by a content control server 116B at the host company's own facility. In another embodiment, a host company may select whether (i) its host web site server 118A is controlled by the first content control server 116A in the network provider system 114 or (ii) its host company web site server 118D is controlled by the second content control server 116B at the host company's own facility.

In the embodiments described below, a limited-display device, such as device 102A in FIG. 1, sends a request to the wireless carrier facility 106 for Internet content to be transferred to the limited-display device 102A. In another embodiment, a client device 105A (e.g., desktop computer) or some other device may send a request to the wireless carrier facility 106 for Internet content to be transferred to one or more of the limited-display devices 102A-102G.

Freeform Browsing/Content Distillation

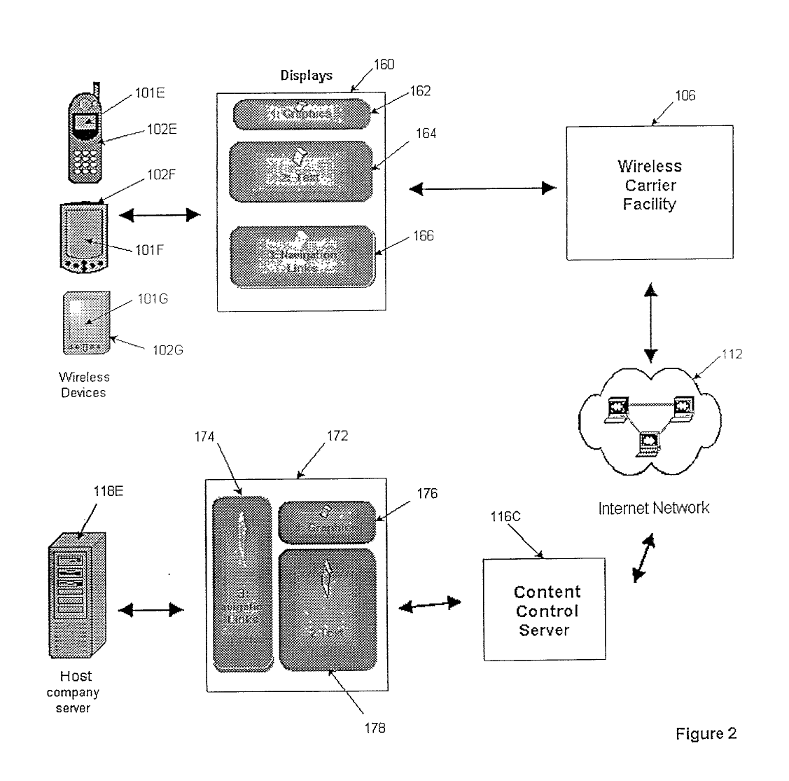

FIG. 2 illustrates an environment for a system, according to an embodiment of the present invention, for transforming a PC-size web page 172 or web content from a host company server 118E to a web page 160 or web content configured to fit a limited-display 101E, 101F, 101G of the wireless devices 102E, 102F, 102G. In FIG. 2, the wireless devices 102E, 102F, 102G are configured to communicate with a wireless carrier facility 106. The wireless carrier facility 106 is configured to communicate with a content control server 116C and/or a host company server 118E via an Internet 112.

In FIG. 2, the host company server 118E and the content control server 116C may be located in the network provider system 114 in FIG. 1 or at the host company system 120 in FIG. 1. The server 116C may be a standard computer server or general purpose machine that is capable of executing software to perform freeform browsing, content distillation, etc. Alternatively, the server 116C may be a device specifically configured to perform freeform browsing, content distillation, etc.

In FIG. 2, web content on a PC-size web page 172 may comprise, for example, navigation links 174, graphics 176, and text 178. The navigation links 174 may comprise, for example, hyperlinks that allow a user to select and access other links, web pages, text and/or graphics. The graphics 176 may comprise, for example, photographs, drawings, images, maps, graphic designs, logos, videos, etc. The graphics 176 may be formatted in one or more formats, such as Graphics Interchange Format (GIF), Joint Photographic Experts Group (JPEG), etc. The text 178 may comprise, for example, articles, tables, emails, etc.

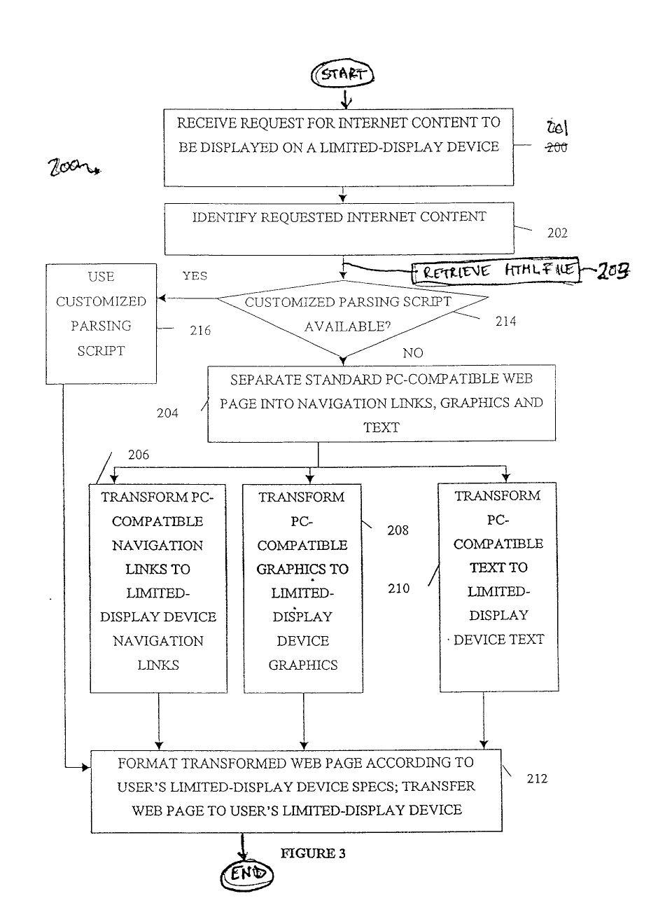

FIG. 3 illustrates one embodiment of a method 200 related to system of FIG. 2. The system and method 200 shown in FIGS. 2 and 3 may advantageously transform any PC-size web page 172 (not just web pages with customized parsing scripts) or web content from any web server automatically and on-the-fly to provide real-time Internet access to wireless, limited-display devices 102E, 102F, 102G. This real-time access to any web page on a limited-display device 102E may be called “freeform browsing.” In a start block 201 of FIG. 3, a request (e.g., a HyperText Transfer Protocol (HTTP) request) for Internet content may be received from a user at a wireless device, such as the device 102E. The request may be issued on any on the limited-display devices 102E-102G or some other device, such as a client device (e.g., a desktop computer). The wireless device 102E transfers the request to the wireless carrier facility 106, which transfers the request to a corresponding host company server 118E and/or the content control server 116C.

In a block 202, the host company server 118E and/or the content control server 116C identifies the requested Internet content. In a block 203, the content control server 116C executes software that retrieves a HyperText Markup Language (HTML) file, such as a PC-size web page 172, requested by the user. In one configuration, the software comprises a Common Gateway Interface (CGI)/Perl page-parsing script.

In a block 214, the software determines whether there is a pre-existing customized parsing script available for the user-requested PC-size web page 172. Customized parsing scripts may be created by (i) a host company through a web browser at the host company system 120; (ii) a wireless, limited-display device user through a web browser on a user PC; or (iii) a content control company managing the content control server 116C. Host companies, wireless, limited-display device users, and content control companies create customized parsing scripts by pre-selecting which items (e.g., navigation links, graphics, text) on a PC-size web page 172 they wish to display on the limited-display devices 102E, 102F, 102G.

The content control server 116C and/or the host company server 118E may store a plurality of customized parsing scripts for a plurality of PC-size web pages. Customized parsing scripts created by a wireless, limited-display device user may be stored under a user profile in the content control server 116C and/or the host company server 118E.

A customized page-parsing script may comprise one or more “templates.” A company that hosts a web site or a support company may pre-design and modify the templates to control the content and/or format of its content for wireless, limited-display devices 102E, 102F, 102G. For example, one template executed by the content control server 116C transfers a company logo or icon on a PC-size web page 172 onto a wireless, limited-display web page 160, regardless of whether other graphics are transferred or altered. Another template may transfer a center column of text on a PC-size web page 172 to a wireless, limited-display web page 160, and transfer text on the left and right sides of the center column in a less prominent screen location, in an abbreviated format or not at all. The center column text often contains the most important information. Yet another template may transfer only text on a PC-size web page 172 to a wireless, limited-display web page 160, and not transfer any navigation links 174 or graphics 176. A variety of templates may be used to parse particular items of a web page.

If it is determined at block 214 that there is a pre-existing customized parsing script available for the user-requested PC-size web page 172, then the content control server 116C uses that customized parsing script in a block 216 to parse the user-requested PC-size web page 172. The customized parsing script outputs a parsed web page through an output module.

In a block 212, the output module formats the parsed user-requested web page according to the specifications of each particular wireless device 102E, 102F, 102G. For example, if a particular wireless device 102E cannot display tables, the output module may output a page with modified spacing to achieve good readability. If a particular wireless device 102E is WAP enabled, the Internet content will be presented using Wireless Markup Language (WML). If a particular wireless device 102E is iMode enabled, the Internet content will be presented using cHTML.

The content control server 116C then transfers the parsed web page 160 to the wireless carrier facility 106. The wireless carrier facility 106 may cache the parsed web page in the cache machine(s) 110 (FIG. 1), as described below, for efficient retrieval by other wireless device users. The cache machines 110 eliminate the need to execute parsing scripts over and over again when other wireless device users later request the same web page or Internet content. The wireless carrier facility 106 transfers the parsed web page 160 to the wireless device 102E for display.

If it is determined at block 214 that there is no pre-existing customized parsing script available for the user-requested PC-size web page 172, then the content control server 116C executes one or more general “freeform” page-parsing scripts in a block 204. The freeform page-parsing scripts may reside on content control server 116C. The use of customized parsing scripts and freeform page-parsing scripts, alone or in combination, may be part of a process referred to as “distilling content” or “content distillation.” One freeform page-parsing script identifies and separates the elements of the PC-size web page 172 into at least three categories: navigation links 174, graphics 176, and text 178. Other categories may be used, such as tables (e.g., an HTML-formatted matrix of rows and columns that appear on a web page). The navigation links 174, graphics 176, text 178, tables, logos, and positioning information may be stored in a database at the content control server 116C, the host company server 118E or at the host company system 120 in the database 126 (FIG. 1). The freeform page-parsing script may remove certain formatting tags, such as tags for tables, column span (colspan), row span (rowspan), etc.

In a block 206, a freeform page-parsing script transforms some or all of the navigation links 174 on a PC-compatible web page 172 to navigation links 166 for a wireless, limited-display device 102E. In one embodiment, the freeform page-parsing script omits some less important links 174 on the PC-size web page 172 and/or groups some links 174 together to form one link 166 on the wireless, limited-display device web page 160. For example, the freeform page-parsing script may group a “pro football” link, a “college football” link and a “high school football” link on a PC-size sports web page 172 under a single “football” link for a wireless, limited-display device web page 160. The freeform page-parsing script may search for a common term, such as “football,” to group the links. In another embodiment, a freeform page-parsing script condenses a navigation link 174 on a PC-size web page 172 to be displayed on a wireless, limited-display device web page 160. For example, the freeform page-parsing script may condense a “United States Year 2000 Presidential Election Polls” link to a “Presidential Polls” link to be displayed on a wireless, limited-display device web page 160.

In a block 208, a freeform page-parsing script transforms some or all of the graphics 176 on a PC-compatible web page 172 to graphics 162 for a wireless, limited-display device 102E. For example, the freeform page-parsing script may (i) omit graphics 176 from the PC-size web page 172, (ii) reduce the size of the graphics 176, (iii) substitute short descriptions for the graphics 176, and/or (iv) recognize any text in the graphic and process the text.

In a block 210, a freeform page-parsing script transforms some or all of the text 178 on a PC-compatible web page 172 to text 164 for a wireless, limited-display device 102E. For example, the freeform page-parsing script may distill, condense, filter, summarize or otherwise transform the text 178. Methods of distilling text are described below.

In block 212, the content control server 116C formats the transformed web page according to the specifications of the user's particular wireless device. The content control server 116C then transfers the transformed navigation links 166, graphics 162 and text 164 to the wireless carrier facility 106, which transfers the transformed navigation links 166, graphics 162 and text 164 to the wireless device 102E for display.

Instead of or in addition to using templates, the content control server 116C may execute one or more freeform page-parsing scripts that determine what is the most important or desired content on a PC-size web page 172 to transfer to a wireless, limited-display device web page 160.

One embodiment of a freeform page-parsing script first transfers the largest one or more links, graphics and/or text on a PC-size web page 172 to a wireless, limited-display device web page 160. The largest items on a PC-size web page 172 may be the most desired information. Another embodiment of a freeform page-parsing script transfers text with font sizes greater than a predetermined size (e.g., size 14) on a PC-size web page 172 to a wireless, limited-display device web page 160. The largest text on a PC-size web page 172 may contain the most important information. Yet another embodiment of a freeform page-parsing script transfers the most recently added one or more links, graphics and/or text on a PC-size web page 172 to a wireless, limited-display device web page 160. Still another embodiment of a freeform page-parsing script transfers one or more links, graphics and/or text near the top of a PC-size web page 172 to a wireless, limited-display web page 160. Another embodiment of a freeform page-parsing script transfers one or more links, graphics and/or text near the center of a PC-size web page 172 to a wireless, limited-display device web page 160. Yet another embodiment of a freeform page-parsing script transfers links, graphics and/or texts on a PC-size web page 172 based on their color or brightness to a wireless, limited-display device web page 160.

Another embodiment of a freeform page-parsing script distills text on a PC-size web page 172 to produce an abstract that is transferred to a wireless, limited-display web page 160. The abstract is intended to capture the essence of the text on the PC-size web page 172. In one configuration, text distillation is triggered if the text is longer than a predetermined threshold length, such as for example, 100 words. In one configuration, the abstract comprises the first three to five sentences of a piece of text. In another configuration, the abstract comprises the first three to five sentences of a piece of text and the last three to five sentences of the text.

In another configuration, the abstract comprises a plurality of nouns, pronouns, verbs, adjectives and/or adverbs that appear more than once or a number pre-selected by the content control company or the host company. In one configuration, the freeform page-parsing script may be “trained” to generate a more accurate abstract by adjusting the weight or load of certain words or phrases, such as nouns, pronouns, proverbs, adjectives and/or adverbs. For example, a freeform software-parsed abstract of an article is compared to a human-written abstract of the article. Depending on the accuracy of the freeform software-parsed abstract, the weight or load of certain words or phrases are increased or decreased in the freeform parsing script.

In another configuration, the abstract may comprise words or phrases that have a special format, e.g., bold, Italics, or underlining, and sentences with such specially-formatted words or phrases. In another configuration, the abstract comprises phrases or sentences with dates.

In one embodiment, a freeform page-parsing script may distill or transform video and audio pieces that are accessible via the Internet. In another embodiment, a freeform page-parsing script may parse Internet content based on a user's past Internet activities. For example, the page-parsing script may automatically transfer Internet content related to a particular basketball team to a limited-display device 102E if the user repeatedly requests Internet content related to that basketball team. As another example, the page-parsing script may distill out other stock quotes if the user repeatedly requests stock quotes on one or more particular stocks.

Various freeform page-parsing scripts described herein may be combined. In addition, freeform page-parsing scripts may be combined with one or more templates. The content control server 116C may use freeform page-parsing scripts and templates in any order. For example, the content control server 116C may use a first freeform page-parsing script, a first template, and then a second freeform page-parsing script. As another example, the content control server 116C may use a first template and then a first freeform page-parsing script.

In one embodiment, items on a PC-size web page 172 that are not transferred to a wireless, limited-display web page 160 are grouped together and made accessible by the user under a navigation link such as “other items” on the wireless, limited-display web page 160.

In one embodiment, after content distillation, the content control server 116C executes a translation software to transform distilled navigation links and/or text from the PC-size web page 172 into non-English navigation links and/or text to be displayed on the limited-display device web page 160. For example, the content control server 116C may transform distilled navigation links and/or text in English into Mandarin Chinese.

In one embodiment, after content distillation, the content control server 116C executes a software to transform the navigation links 174 and/or text 178 into audio samples, e.g., voice, to be output by one or more user devices 102E, 102F, 102G.

In one embodiment, the content control server 116C recognizes the distilled Internet content and inserts advertisements related to the distilled Internet content on-the-fly to be sent to the limited-display devices 102E-102G.

Targeted Content Delivery Based on Location

In one embodiment, the content control server 116C executes a particular page-parsing script based on the location of the limited-display device 102E-102G. The content control server 116C may determine the location of a limited-display device 102EG by determining, for example, the location of the wireless carrier facility 106, the location of the communication tower 104A-104D which received the request for Internet content, or the location of the limited-display device 102A-102G which will receive the Internet content. Alternatively, the limited-display device 102E-102G may have a global positioning system (GPS) module.

For example, the content control server 116C may parse and transfer only local or regional Internet content, such as news, special event information, weather reports or warnings, traffic reports, sports, business, advertising, the location of certain restaurants, stores, movie theaters, etc., to one or more limited-display devices 102A-102G, based on the location of the limited-display devices 102E-102G.

In one configuration, the content control server 116C executes a location-based page-parsing script in response to a user request. In another configuration, the content control server 116C automatically executes a location-based page-parsing script and sends Internet content to the limited-display devices 102E-102G as updates or warnings. In one configuration, the content control server 116C automatically executes a location-based page-parsing script and sends Internet content to a limited-display device 102E when the limited-display device 102E moves to another region, such as a wireless cell.

In one configuration, the content control server 116C continuously executes location-based page-parsing scripts and sends Internet content to a limited-display device 102E in real time.

The content control server 116C may access one or more web sites or use one or more search engines, e.g., a meta search, to find location-specific Internet content.

One-Hop Caching

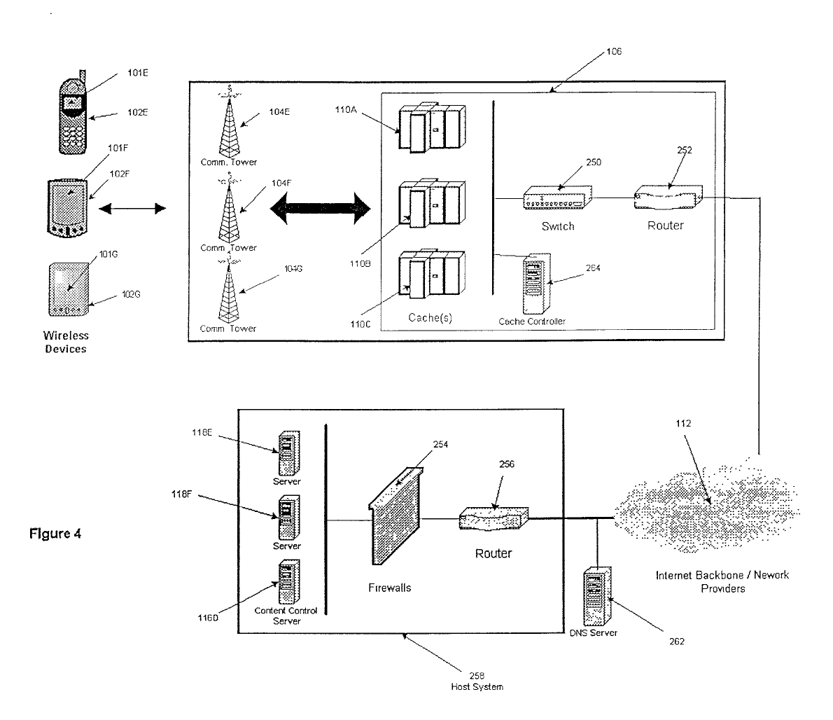

FIG. 4 illustrates an environment for a system, according to an embodiment of the present invention, for caching Internet content. The environment includes limited-display devices 102E-102G, communication towers 104E-104G, a wireless carrier facility 106 and a host system 258. The wireless devices 102E, 102F, 102G are configured to communicate with a wireless carrier facility 106 via the communication towers 104E-104G. The wireless carrier facility 106 is configured to communicate with the host system 258 via the Internet 112.

In FIG. 4, the wireless carrier facility 106 comprises a first cache machine 110A, a second cache machine 110B, a third cache machine 110C, a switch 250, a router 252, and a cache controller 264. The wireless carrier facility 106 may comprise any number of cache machines, switches, routers, and servers.

In one embodiment, the switch 250 is a Layer 4 (L4) switch in an Open Systems Interconnect model (OSI), which has seven layers to describe networking protocols. Layer 4 represents a transmission control protocol (TCP) layer, i.e. the data transport layer. Layer 3 represents an Internet protocol (IP) layer. Layer 5 represents a HTTP layer. Layer 6 represents a secure socket layer (SSL) layer. A Layer 4 switch switches packets to appropriate destinations on the Internet 112. In one embodiment, the switch 250 of FIG. 4 acts as a load balancer, which spreads or partitions a stream of HTTP data (requested by the user or posted by host companies) from the Internet 112 across the cache machines 110A-110C in the cluster.

The cache machines 110A-110C may be organized as a cluster and coupled to the switch 250, which is coupled to the router 252. The cache machines 110A-110C may be general purpose computers configured to execute cache software or devices configured specifically to cache data. The cache controller 264 may be any suitable computer, server, microcontroller or other device that controls the storage and retrieval of data to and from the cache machines 110A-110C.

Although FIG. 4 illustrates the cache machines 110A-110C at the wireless carrier facility 106, the cache machines 110A-110C may be located anywhere between the limited-display devices 102E-102G and the host system 258 operated by a host company. The cache machines 110A-110C are located remote from the host system, and preferably outside a host company's firewalls 254. The host company does not have to modify its existing corporate web infrastructure. This placement of the cache machines 110A-110C ensures a high level of security and does not overburden the firewalls with excessive traffic.

In FIG. 4, the host system 258 comprises a first server 118E, a second server 118F, a content control server 116D, one or more firewalls 254 and a router 256. The host system 258 may comprise any number of servers, firewalls and routers. In one embodiment, the content control server 116D is a general purpose machine or a standard computer server configured to execute software described herein. In another embodiment, the content control server 116D is a device specifically configured to perform the functions described herein.

The servers 116D, 118E, 118F are coupled to firewalls 254, which are coupled to the router 256. The firewalls 254 comprise software and/or hardware that protects the servers 116D, 118E, 118F from third parties trying to interfere with the servers 116D, 118E, 118F via the Internet 112.

The host system 258 of FIG. 4 may represent either the network provider system 114 or the host company system 120 of FIG. 1. If the host system 258 represents the network provider system 114 of FIG. 1, then the host system 258 further comprises a DNS server 262. If the host system 258 represents the host company system 120 of FIG. 1, then the host system 258 may be coupled to a DNS server 262, as shown in FIG. 4. The DNS server 262, or one of the other servers 118E, 118F, 116D, may be modified or programmed to (i) direct web traffic to the cache machines 110A-110C and (ii) direct requests for Internet content (to be displayed on limited-display devices) to the content control server 116D. The DNS server 262 may determine where the request originated and where the requested Internet content should be displayed.

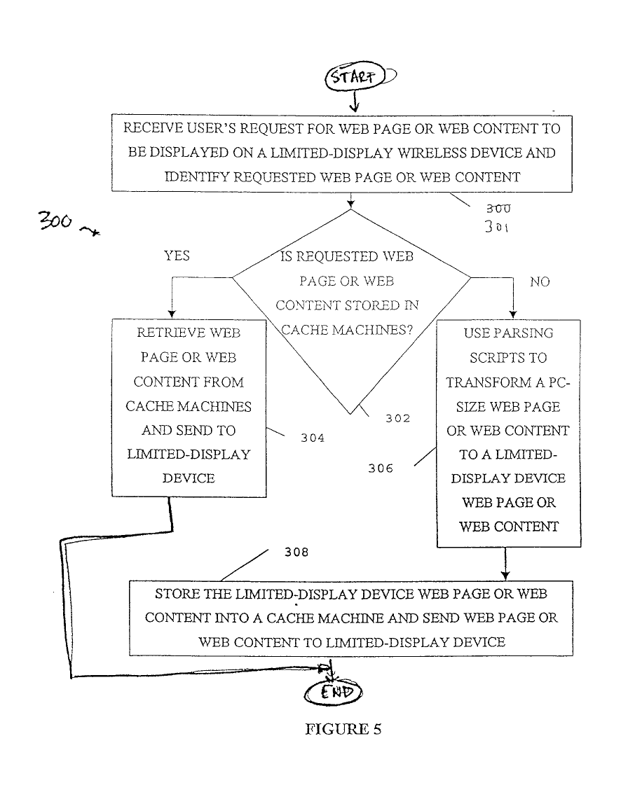

FIG. 5 illustrates one embodiment of a method 300 for caching and retrieving Internet content using the system of FIG. 4. In a block 301, the wireless carrier facility 106 receives from a user a request for a web page and/or web content to be displayed on a limited-display device 102E. The request may be sent from the limited-display device 102 that will receive the Internet content, another limited-display device 102F-102G, or another device, such as a PC. The cache controller 264 at the wireless carrier facility 106 receives the request and identifies the requested web page or web content. In a block 302, the cache controller 264 determines whether the requested web page or web content is stored in the cache machines 110A-110C.

If the requested web page or web content is stored in the cache machines 110A-110C, then the cache controller 264 retrieves the web page or web content from the cache machines 110A-110C and sends the web page or web content to the limited-display device 102E in a block 304. This may be referred to as a “one-hop” transfer of Internet content.

If some of the requested web pages or web content is not stored in the cache machines 110A-110C, then the cache controller 264 sends the user request to the content control server 116D in the host system 258. In a block 306, the content control server 116D uses page-parsing scripts to transform a user-requested PC-size web page or web content into a limited-display device web page or web content. The page-parsing scripts are described above with reference to FIGS. 1-3. The content control server 116D then transfers the limited-display device web page or web content to the cache controller 264.

In one configuration, the cache controller 264 sends a request to the content control server 116D to only parse the web page or web content that is not already stored in the cache machines 110A-110C. This configuration reduces the amount of page-parsing performed by the content control server 116D and reduces the amount of web content sent to the cache controller 264 via the Internet 112.

In a block 308, the cache controller 264 sends the limited-display device web page or web content to the limited-display device 102E. In one configuration, the cache controller 264 caches all of the limited-display device web pages or web content from the content control server 116D into one or more cache machines 110A-110C.

Thus, the cache machines 110A-110C minimize the delay time (“latency”) that users must wait to access certain Internet content on their limited-display devices 102E-102G. By caching Internet content, the system of FIG. 4 reduces the number of transmissions (“hops”) between network components, minimizes user waiting time (“latency”), improves performance and uses less bandwidth.

In another configuration, the cache controller 264 does not cache all of the limited-display device web pages or web content from the content control server 116D into one or more cache machines 110A-110C. Instead, the cache controller 264 keeps track of the number of times (“hit rate”) that a web page or web content has been requested by limited-display device users. To save cache memory space, the cache controller 264 may cache only web pages or web content that have been requested (“hit”) a predetermined number of times, e.g., five times, within a predetermined time, e.g., one week. The predetermined number of request times and time period may be set by a web site host company or a content control company.

In one configuration, the cache controller 264 automatically erases cached web pages or web content after a predetermined time period, e.g., one week, unless a “save” or “refresh” command is received from a host company. Each web page or web content stored in the cache machines 110A-110C has a time stamp and/or date stamp. The time period may be predetermined by a web site host company or a content control company. In another configuration, the cache controller 264 automatically erases cached web pages or web content if there has been no user request for the cached web pages or web content after a predetermined time period, e.g., one week, unless a “save” or “refresh” command is received from a host company.

In one embodiment, the host system 258 can randomly or periodically pre-load (“post” or “push”) new web pages and web content into the cache machines 110A-110C at any time, without a user request. The host company may use the content control server 116D, a separate computer, a control panel or a device executing an enterprise-level software application to send new web pages or web content to the cache controller 264. The cache controller 264 stores the new web pages or web content into the cache machines 110A-110C. The same software application may also allow the host company to create templates, modify templates, and control content distillation. Pre-loading web pages and web content allows host companies to directly control the Internet content that will be sent to the limited-display devices 102E-102G.

In one embodiment, the host system 258 may also update or modify the Internet content (either user-requested or pre-loaded by host company) that is currently stored in the cache machines 110A-110C.

In one embodiment, the cache controller 264 is configured or programmed to automatically retrieve (“pull”) Internet content from one or more host systems 258 at periodic or random times, without a user request. Thus, the cache controller 264 may update the web pages or web content stored in the cache machines 110A-110C.

Each of the caching embodiments and configurations described above may be customized to suit the needs of a particular host company. Each host company may implement various caching embodiments and/or configurations.

In one embodiment, the system 260 may cache different Internet content based on a location or region of the limited-display devices, the communication towers and/or the cache machines. For example, Internet content cached for California may be different than Internet content cached for New York.

Coordinating Content Between Devices—Content Flagging

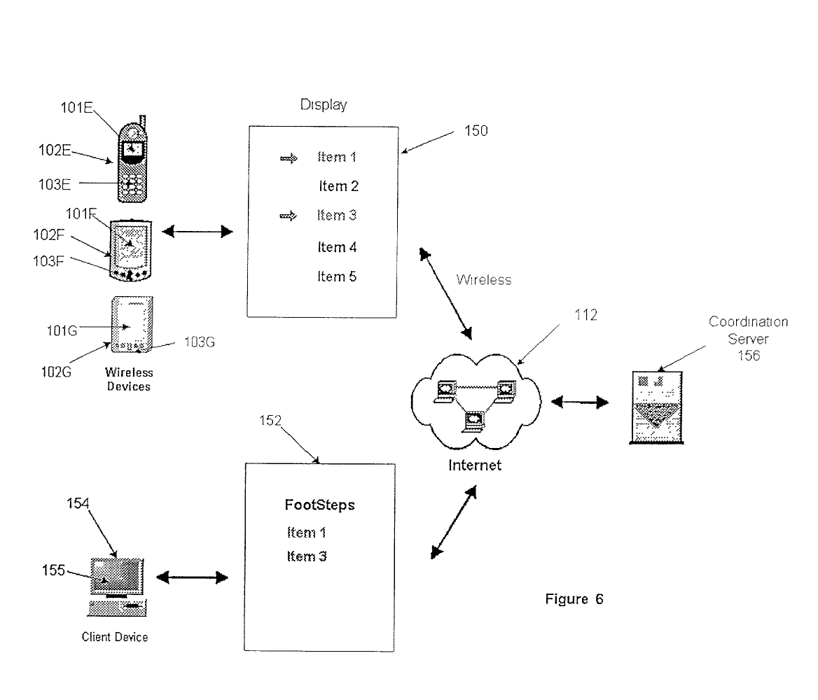

FIG. 6 illustrates an environment for a system, according to an embodiment of the present invention, for coordinating browsing activities between a client device (e.g., a PC) 154 and one or more limited-display devices 102E-102G. FIG. 6 illustrates a first display page 150, a second display page 152, a first, second and third limited-display devices 102E-102G, the Internet 112, a coordination server 156, and a client device 154. The system of FIG. 6 may comprise any number of limited-display devices, coordination servers and client devices.

In FIG. 6, the limited-display devices 102E-102G communicate with the coordination server 156 and the client device 154 via the Internet 112 and/or other forms of communication, such as cellular, personal communication system (PCS), satellite, radio, etc. For example, the limited-display devices 102E-102G may communicate with a wireless carrier facility 106 as in FIG. 1, which communicates with the client device 154 via the Internet 112. The coordination server 156 communicates with the client device 154 via the Internet 112.

In one embodiment, the coordination server 156 comprises a general purpose machine or a standard web server executing coordination software. The coordination software may be incorporated with some or all of the software described above, such as freeform browsing, content distillation, and caching. In another embodiment, the coordination server 156 comprises a device specifically configured to coordinate browsing activities between a client device 154 and one or more limited-display devices 102E-102G. In the latter case, the coordination server 156 is in communication with a web site server, such as the web site servers 118A or 118D in FIG. 1.

The client device 154 of FIG. 6 may comprise any type of computer, such as lap top, notebook, desktop computer or electronic device configured to access the Internet 112.

In FIG. 6, the first display page 150 represents one configuration of a page that may be displayed on one of the displays 101E-101G of the limited-display devices 102E-102G. The second display page 152 represents one configuration of a PC display page, such as a web page, that may be displayed on the display 155 of the client device 154. The first and second display pages 150, 152 are illustrated as simple examples. Internet content may be displayed in various formats.

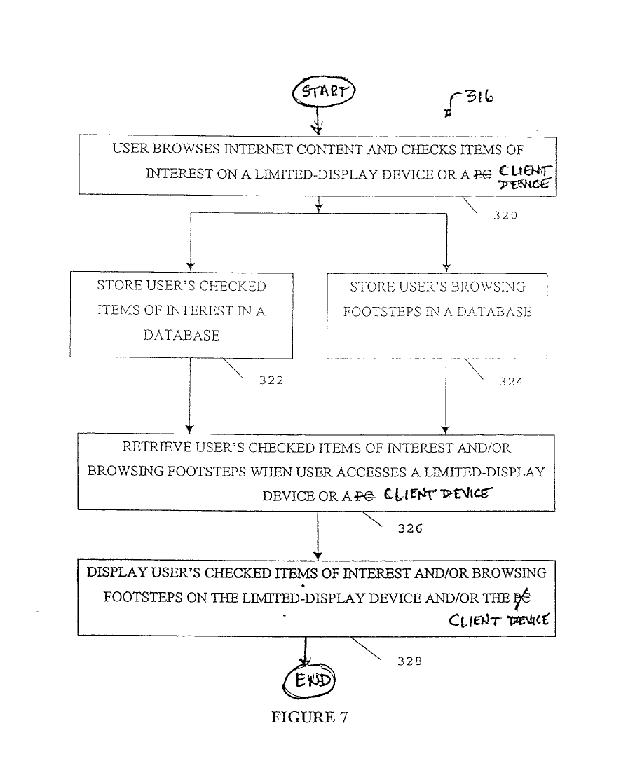

FIG. 7 illustrates one embodiment of a method 316 for coordinating browsing activities between a client device 154 and one or more limited-display devices 102E-102G using the system of FIG. 6. In a block 320, a user browses Internet content on one of the limited-display devices 102E-102G or the client device 154. In one embodiment, the user logs onto a coordination web site supported by the coordination server 156 and browses Internet content through the coordination web site. The coordination web site provides users with access to other web sites. In another embodiment, the coordination server 156 monitors the user's browsing automatically without a log-on to the respective coordination web site.

As the user browses, the user may check or flag particular Internet content items of interest to the user, such as web sites, web pages, articles, emails, navigation links, graphics, maps, products and merchandise, etc. In FIG. 6, for example, the user checks Internet Items 1 and 3 on one of the limited-display devices 102E-102G by pressing one or more keys on a keypad 103E-103G. The user may check Internet items by other means, such as touching a light or pressure sensitive screen (e.g., touch screen), or by voice commands.

In a block 322, the coordination server 156 tracks and stores the user's checked items of interest, Items 1 and 3, in a memory within the coordination server 156 or some other device in communication with the coordination server 156.

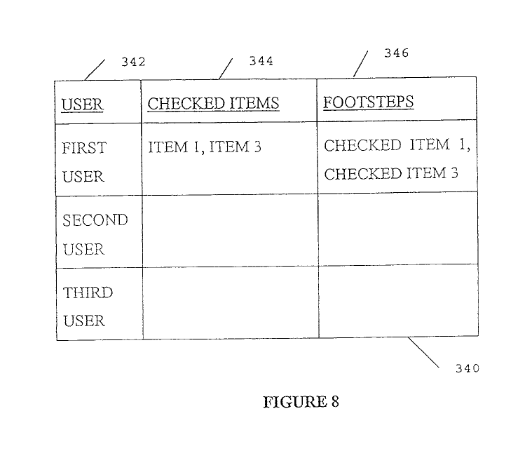

FIG. 8 illustrates one embodiment of a database/table 340 used by the coordination server 156 of FIG. 6. The table 340 comprises at least three columns: a user identification column 342, a checked item column 344 and a footstep column 346. The user identification column 342 may comprise information for users' names, email addresses, social security numbers, account numbers, or any other information for identifying users. The checked items column 344 may comprise information for web sites, web pages, articles, emails, links, graphics, HTML files, WML files, or any other content item of interest to a user. In one configuration, to conserve memory space, the checked items column 344 may only comprise an address or link, such as a universal resource locator (URL), to the actual Internet item. The footstep column 346 may comprise information for links, HTML files, WML files, time and date entries, or anything else that enables the “path” to a particular content item to be re-created.

In one configuration, each user may have multiple rows to account for multiple Internet browsing sessions. The multiple browsing sessions for each user may be categorized by hour, day, week, month and/or year. The coordination server 156 may delete rows that have not been accessed by a user for over a period of time, such as a month.

The coordination server 156 finds the appropriate user row via the user identification column 342 and stores the user's checked items, Items 1 and 3, in the checked item column 344.

In a block 324, the coordination server 156 tracks and stores the user's browsing footsteps in the database/table 340, for example, at footstep column 346. Browsing footsteps may include any form of navigation or item selection on the Internet. In this example, the user's footsteps include checking Item 1 and checking item 3. In FIG. 7, the coordination server 156 may perform the acts in blocks 322 and 324 serially or in parallel.

In a block 326, when the user accesses one of the limited-display devices 102E-102G or the client device 154, the coordination server 156 retrieves the user's checked items of interest, Items 1 and 3, and/or the user's browsing footsteps. In one embodiment, the coordination server 156 retrieves the user's checked items of interest and/or the user's browsing footsteps when the user logs onto the coordination web site. In one configuration, the user's previously flagged Internet items are accessible via a link, such as “Flagged Items.” In one configuration, the user's previous footsteps are accessible via a link, such as “Footsteps.”

In a block 328, the coordination server 156 causes one of the limited-display devices 102E-102G or the client device 154 to display the user's checked items of interest, Items 1 and 3, either automatically or in response to a user command. The coordination server 156 may transform the format of the checked items to accommodate the size of the limited display area 101E-101G and/or one or more specifications of the limited-display devices 102E-102G. For example, the coordination server 156 may use templates and/or page parsing to transform PC-formatted Internet content to limited-display device formatted Internet content, as described above.

In addition to or instead of displaying the user's checked items of interest (Items 1 and 3), the coordination server 156 may cause one of the limited-display devices 102E-102G or the client device 154 to display the user's browsing footsteps.

The system of FIG. 6 may also be configured to coordinate browsing activities between two or more limited-display devices 102E-102G. Also, the system allows a user to check items of interest at a client device 154 and access those items later at a wireless, limited-display device, such as the devices 102E-102G.

Thus, the system of FIG. 6 advantageously coordinates Internet browsing on two separate devices. The system saves time for users who flag certain Internet items on a portable device “on-the-go” and later wish to access those items quickly at another device at home, at an office, in a hotel room, on a plane, at a conference, etc.

Virtual Cradle/Synchronization

The system of FIG. 6 may be used to synchronize, copy or update information stored on one or more of the limited-display devices 102E-102G and/or the client device 154. The information may comprise appointments, schedules, contact information, such as telephone numbers, work/home addresses, email addresses, to-do lists, expense reports. Thus, no matter where a user travels, the user may access up-to-date business information and schedules.

Specifically, a user may update or change information stored on a wireless limited-display device 102E while the user is at a first location. For example, the user may add or change a scheduled meeting in a stored weekly schedule. The coordination server 156 is configured to track changes made by the user on the limited-display device 102E by using the table 340 of FIG. 8 or some other database. When the user accesses the client device 154 or another limited-display device 102F, 102G, the coordination server 156 provides a copy of the added or changed information to the client device 154 or other limited-display device 102F, 102G.

In one configuration, the coordination server 156 automatically updates (“synchronizes”) information stored in some or all of the limited-display devices 102E-102G and the client device 154 after the user changes or adds information at one device. In another configuration, the user presses a key or selects a menu option to update information.

In one embodiment, other users at other limited-display devices or client devices may update and/or access the same stored information. This minimizes the data re-entry problem.

The distillation system and methods disclosed herein can be used to distill emails, attachments to emails, as well as web content. The distilled content may then be displayed on a wireless or a wired device. For example, the distilled content may be displayed on a Research In Motion (RIM) device or a Palm device.

Various types of wireless, limited-display devices, wired devices, servers, cache devices, switches, routers, and Internet components may be used in accordance with the present invention. The scope of the present invention is not limited to a particular type of wireless, limited-display device, wired device, server, cache device, switch, router or Internet component. Other embodiments of the system may comprise other components in addition to or instead of the components described herein without departing from the scope of the invention.

The above-described embodiments of the present invention are merely meant to be illustrative and not limiting. It will thus be obvious to those skilled in the art that various changes and modifications may be made without departing from this invention in its broader aspects. The appended claims encompass all such changes and modifications as fall within the true spirit and scope of this invention.

What is claimed is:

1. A content control server for controlling the transfer of Internet content to a limited-display device the content control server operable to communicate with a web server and the limited-display device, the content control server configured to store a customized parsing script, the content control server further configured to receive a user request for Internet content to be displayed on the limited-display device, the content control server further configured to execute the customized parsing script to parse items in the user-requested Internet content in real time, the content control server further configured to transfer parsed Internet content to the limited-display device.

2. The content control server of claim 1, wherein the items comprise a navigation link, a piece of text, or a graphic.

3. The content control server of claim 1 further configured to modify the items in the user-requested Internet content before transferring the items to the limited-display device.

4. The content control server of claim 1 further configured to format the items in the user-requested Internet content to at least one specification of the limited-display device before transferring the items to the limited-display device.

5. The content control server of claim 1 further configured to store one or more freeform parsing scripts, the content control server further configured to execute a freeform parsing script to parse items in the user-requested Internet content in real time.

6. A content control server for controlling the transfer of Internet content to a limited-display device, the content control server operable to communicate with a web server and the limited-display device, the content control server configured to receive a request for Internet content to be displayed on the limited-display device, the content control server being further configured to parse PC-formatted Internet content in real time, the content control server being further configured to transfer the parsed Internet content to the limited-display device.

7. The content control server of claim 6, wherein the requested Internet content comprises a web page.

8. The content control server of claim 6 further configured to separate the requested Internet content into a navigation link, a graphic, or a piece of text.

9. The content control server of claim 6 further configured to remove a navigation links from the requested Internet content to form the parsed Internet content transferred to the limited-display device.

10. The content control server of claim 6 further configured to group at least two navigation links together from the requested Internet content to form one navigation link in the parsed Internet content transferred to the limited-display device.

11. The content control server of claim 6 further configured to condense at least one navigation link in the requested Internet content to form the parsed Internet content transferred to the limited-display device.

12. The content control server of claim 6 further configured to remove a graphic in the requested Internet content to form the parsed Internet content transferred to the limited-display device.

13. The content control server of claim 6 further configured to reduce a size of a graphic in the requested Internet content to form the parsed Internet content transferred to the limited-display device.

14. The content control server of claim 6 further configured to preserve a center column of text in the requested Internet content and move text on left and right sides of the center column to a less prominent location to form the parsed Internet content for the limited-display device.

15. The content control server of claim 6 further configured to preserve a center column of text in the requested Internet content and distill text on left and right sides of the center column of text in the requested Internet content to form the parsed Internet content for the limited-display device.

16. The content control server of claim 6 further configured to preserve a center column of text in the requested Internet content and remove text on left and right sides of the center column of text in the requested Internet content to form the parsed Internet content for the limited-display device.

17. The content control server claim 6 further configured to determine relative sizes for a plurality of items in the requested Internet content and remove at least one smaller item to form the parsed Internet content for the limited-display device.

18. The content control server claim 6 further configured to remove a piece of text in the requested Internet content based on a font size of the piece of text to form the parsed Internet content for the limited-display device.

19. The content control server claim 6 further configured to remove an item in the requested Internet content based on a date when the item was added in the requested Internet content to form the parsed Internet content for the limited-display device.

20. The content control server claim 6 further configured to remove one or more items on left and right sides of a center item in the requested Internet content to form the parsed Internet content for the limited-display device.

21. The content control server claim 6 further configured to remove one or more items below a top item in the requested Internet content to form the parsed Internet content for the limited-display device.

22. The content control server claim 6 further configured to remove an item based on a color of the item in the requested Internet content to form the parsed Internet content for the limited-display device.

23. The content control server claim 6 further configured to remove an item based on a brightness of the item in the requested Internet content to form the parsed Internet content for the limited-display device.

24. The content control server claim 6 further configured to generate an abstract from a piece of text in the requested Internet content to form the parsed Internet content transferred to the limited-display device.

25. The content control server claim 24 further configured to generate an abstract from a piece of text in the requested Internet content if the piece of text is longer than a predetermined threshold length to form the parsed Internet content transferred to the limited-display device.

26. The content control server of claim 24, wherein the abstract comprises a first three to five sentences of the piece of text.

27. The content control server of claim 24, wherein the abstract comprises a first three to five sentences of the piece of text and the last three to five sentences of the text.

28. The content control server of claim 24, wherein the abstract comprises a plurality of nouns, verbs, adjectives and adverbs that appear more than a predetermined number of times in the piece of text.

29. The content control server of claim 6, wherein the content control server groups together items in the requested Internet content that are not transferred with the parsed Internet content and provides a navigation link for a user to request the non-transferred items.

30. The content control server of claim 6, wherein the limited-display device is a wireless phone.

31. The content control server of claim 6, wherein the limited-display device is a personal digital assistant (PDA).

32. The content control server of claim 6 further configured to communicate with a computer, the content control server further configured to receive a request from the computer for Internet content to be displayed on the limited-display device.

33. A method of transferring Internet content to a limited-display device, the method comprising:
receiving a first request for Internet content to be displayed on a limited-display device;
transforming PC-formatted Internet content into limited-display-formatted Internet content in real time; and
transferring the limited-display-formatted Internet content to the limited-display device.

34. The method of claim 33, further comprising:
determining whether there is a customized parsing script for a PC-size web page with the requested Internet content;
if there is a customized parsing script for the PC-size web page with the requested Internet content, using the customized parsing script to transform the PC-size web page into a limited-display web page; and
if there is no customized parsing script for the PC-size web page with the requested Internet content, using a freeform parsing script to transform the PC-size web page into a limited-display web page.

35. The method of claim 34, further comprising formatting the limited-display web page to at least one specification of the limited-display device before transferring the limited-display web page to the limited-display device.

36. The method of claim 33, further comprising:
caching the limited-display-formatted Internet content;
receiving a second request for Internet content to be displayed on a limited-display device;
determining whether the second request for Internet content matches the first request for Internet content; and
if the second request for Internet content matches the first request for Internet content, transferring the cached limited-display-formatted Internet content to one or more limited-display devices.

37. The method of claim 33, wherein transforming PC-formatted Internet content comprises removing at least one navigation link in the PC-formatted Internet content to form the limited-display-formatted Internet content.

38. The method of claim 33, wherein transforming PC-formatted Internet content comprises grouping two or more navigation links together in the PC-formatted Internet content to form one navigation link in the limited-display-formatted Internet content.

39. The method of claim 33, wherein transforming PC-formatted Internet content comprises condensing one or more navigation links in the PC-formatted Internet content to form the limited-display-formatted Internet content.

40. The method of claim 33, wherein transforming PC-formatted Internet content comprises omitting a graphic in the PC-formatted Internet content to form the limited-display-formatted Internet content.

41. The method of claim 33, wherein transforming PC-formatted Internet content comprises reducing a size of a graphic in the PC-formatted Internet content to form the limited-display-formatted Internet content.

42. The method of claim 33, wherein transforming PC-formatted Internet content comprises:
preserving a c enter column of text in the PC-formatted Internet content; and
moving text on left and right sides of the center column in the PC-formatted
Internet content to a less prominent location to form the limited-display-formatted Internet content.

43. The method of claim 33, wherein transforming PC-formatted Internet content comprises:
preserving a center column of text in the PC-formatted Internet content; and
distilling text on left and right sides of the center column of text in the PC-formatted Internet content to form the limited-display-formatted Internet content.

44. The method of claim 33, wherein transforming PC-formatted Internet content comprises:
preserving a center column of text in the PC-formatted Internet content; and
removing text on left and right sides of the center column of text in the PC-formatted Internet content to form the limited-display-formatted Internet content.

45. The method of claim 33, wherein transforming PC-formatted Internet content comprises removing a navigation link or graphic in the PC-formatted Internet content to form the limited-display-formatted Internet content.

46. The method of claim 33, wherein transforming PC-formatted Internet content comprises:
determining relative sizes of items in the PC-formatted Internet content; and
removing one or more smaller items to form the limited-display-formatted Internet content.

47. The method of claim 33, wherein transforming PC-formatted Internet content comprises removing a piece of text based on a font size of the piece of text to form the limited-display-formatted Internet content.

48. The method of claim 33, wherein transforming PC-formatted Internet content comprises removing an item based on a date when the item was added in the PC-formatted Internet content to form the limited-display-formatted Internet content.

49. The method of claim 33, wherein transforming PC-formatted Internet content comprises removing one or more items on left and right sides of a center item in the PC-formatted Internet content to form the limited-display-formatted Internet content.

50. The method of claim 33, wherein transforming PC-formatted Internet content comprises removing one or more items below a first item in the PC-formatted Internet content to form the limited-display-formatted Internet content.

51. The method of claim 33, wherein transforming PC-formatted Internet content comprises removing one or more items based on a color of the items in the PC-formatted Internet content to form the limited-display-formatted Internet content.

52. The method of claim 33, wherein transforming PC-formatted Internet content comprises removing one or more items based on a brightness of the items in the PC-formatted Internet content to form the limited-display-formatted Internet content.

53. The method of claim 33, wherein transforming PC-formatted Internet content comprises generating an abstract from a piece of text in the PC-formatted Internet content to form the limited-display-formatted Internet content, if the piece of text is longer than a predetermined threshold length.

54. The method of claim 33, wherein transforming PC-formatted Internet content comprises generating an abstract from a piece of text in the PC-formatted Internet content to form the limited-display-formatted Internet content, wherein the abstract comprises a first three to five sentences of the piece of text.

55. The method of claim 33, wherein transforming PC-formatted Internet content comprises generating an abstract from a piece of text in the PC-formatted Internet content to form the limited-display-formatted Internet content, wherein the abstract comprises a first three to five sentences of the piece of text and the last three to five sentences of the text.

56. The method of claim 33, wherein transforming PC-formatted Internet content comprises generating an abstract from a piece of text in the PC-formatted Internet content to form the limited-display-formatted Internet content, wherein the abstract comprises a plurality of nouns, verbs, adjectives and adverbs that appear more than a predetermined number.

57. The method of claim 33, further comprising:
grouping together omitted items in the PC-formatted Internet content that are not used to form the limited-display-formatted Internet content; and
providing a navigation link in the limited-display-formatted Internet content for the user to request the omitted items.

58. The method of claim 33, further comprising transforming items in the PC-formatted Internet content into non-English items to form the limited-display-formatted Internet content.

59. The method of claim 33, further comprising transforming items in the PC-formatted Internet content into audio samples to be output by the limited-display device.

60. The method of claim 33, further comprising:
recognizing the limited-display device Internet content; and
inserting advertisements related to the limited-display device Internet content on-the-fly to be sent to the limited-display device.

61. The method of claim 33, further comprising
comparing a software-parsed abstract of a piece of text with a human-written abstract of the piece of text; and
adjusting a weight of certain words or phrases in a parsing software based on the comparison of the software-parsed abstract and the human-written abstract.

62. The method of claim 33, wherein transforming PC-formatted Internet content comprises distilling a video piece.

63. The method of claim 33, wherein transforming PC-formatted Internet content comprises distilling an audio piece.

64. The method of claim 33, wherein transforming PC-formatted Internet content into limited-display-formatted Internet content in real time comprises distilling an email.

65. The method of claim 33, wherein transforming PC-formatted Internet content into limited-display-formatted Internet content in real time comprises distilling an attachment from an email.

66. The method of claim 33, wherein the limited-display device is a wireless device, further comprising displaying the limited-display-formatted Internet content on the limited-display, wireless device.

67. The method of claim 66, wherein the limited-display wireless device is a PalmPilot.

68. The method of claim 66, wherein the limited-display wireless device is a Research In Motion (RIM) device.
